(19) United States
(12) Patent Application Publication
(10) Pub. No.: US 2009/0267928 A1
(43) Pub. Date: Oct. 29, 2009

(54) Display Devices

(75) Inventors: Christopher James Newton Fryer, Cabridgeshire (GB); Richard Guy Blakesley, Cambridge (GB)

Correspondence Address: SUTHERLAND ASBILL & BRENNAN LLP, 999 PEACHTREE STREET, N.E., ATLANTA, GA, 30309, US

(73) Assignee: PELIKON LIMITED, Glamorgan (GB)

(21) Appl. No.: 12/300,867

(22) PCT Filed: May 15, 2007
(86) PCT No.: PCT/GB07/01799

§ 371 Date: May 18, 2009

(30) Foreign Application Priority Data
May 16, 2006 (GB) 0609692.9

(51) Int. Cl. G09G 5/00; G09G 3/30; G09G 3/36

(52) U.S. Cl. 345/211; 345/76; 345/87

(57) ABSTRACT

A drive circuit of a display device comprising a capacitive display (H1) and a further display H2. The drive circuit is arranged to provide to the capacitive display, such as an electroluminescent display, an AC drive signal at a first, high voltage from a low voltage power source such that, in use, the drive circuit is repeatedly charged and discharged. The drive circuit is further arranged such that, when the capacitive display discharges, a discharge current from the display is supplied at a second, lower voltage to the further display. In the way energy from the capacitive display is used to drive a further display rather than being discarded.

This invention relates to display devices comprising capacitive displays such as, typically but non-exclusively, electroluminescent displays.

Certain electroluminescent (EL) displays can have selectively illuminatable regions for displaying information. Such displays have the advantage over competing technologies that they can be large, flexible and are relatively inexpensive.

EL displays generally comprise a layer of phosphor material, such as a doped zinc sulphide powder, between two electrodes. It is usual for at least one electrode to be composed of a transparent material, such as indium tin oxide (ITO), provided on a transparent substrate, such as a polyester or polyethylene terephthalate (PET) film. The display may be formed by depositing electrode layers and phosphor layers onto the substrate, for example by screen printing, in which case opaque electrodes may be formed from conductive, for example silver-loaded, inks. Examples of EL devices as described can be seen in PCT patent application publications number WO00/72638 and WO99/55121.

An EL display of the general type described above is illuminated by applying an AC voltage of an appropriate frequency, which is typically a few tens of Hertz, between the electrodes of the lamp to excite the phosphor. Commonly, the phosphors used in EL displays require a voltage of a few hundred volts.

Similarly, Polymer Dispersed Liquid Crystal (PDLC) displays are also capacitive and require relatively high voltage AC supplies at around 42V. Typically, the displays (EL or PDLC) have a capacitance in the range of 100 pF to 1 μF. At the frequencies typically used, this means that only a small current is required in order to charge the display and therefore the comparatively high drive voltage can be produced from a low voltage DC supply by means of a “flyback converter”. Such a converter can be seen in PCT patent application publication number WO02/069674, a portion of which is attached hereto as Appendix A. By means of an oscillating switch in series with an inductive element such as a coil or transformer, a higher voltage (HV) DC signal can be generated.

This HV DC signal can then be converted to an AC signal by means such as an H-bridge, that is four switches forming two pairs, each pair selectively connecting one electrode of the display to either the HV DC signal or to a reference potential (typically ground). The display can therefore be switched between having a first electrode connected to the HV DC supply with a second connected to ground and having the first electrode connected to ground and the first to the HV DC power supply. AC is therefore generated across the display.

Accordingly, a power supply as described above enables an EL display to be driven from, say 2 standard AA batteries. However, it is sometimes desired to operate different display technologies in the same device, from the same power supply. One typical example is a simple liquid crystal (LC) display, which operates at around 5V AC.

According to a first aspect of the invention, there is provided a display device comprising a capacitive display, a further display and a drive circuit for providing a AC drive signal at a first, high voltage for the display from a low voltage power source, the drive circuit being arranged such that in use the capacitive display repeatedly charges and discharges and when the display discharges a discharge current from the display is supplied at a second, lower voltage to the further display.

This allows generation of a further voltage using energy from the display that would otherwise be discarded. Accordingly, more efficient use of energy is made and the need for a separate power supply for the further display may be removed or reduced. In the preferred embodiment, the second voltage is different, typically higher, than the voltage of the low voltage power source.

Typically, the further display will be a liquid crystal display (LCD). This has been found to be particularly convenient, as a voltage of 4V to 9V, in the region of voltages required by such LCDs, has been found to be achievable from the current discharged from a typical EL display. Alternatively, the further display may be a light emitting polymer (LEP) display, Cholesteric LCD, Electrophoretic displays, Light Emitting Diodes (LEDs) including High Brightness LEDs (HBLEDs), Organic LEDs (OLEDs), or the like.

The discharge current supplied to the further display will generally comprise a DC signal. As certain displays, such as some LCDs, require AC, a DC-to-AC converter such as a H-bridge may be provided for converting the discharge current to AC.

The drive circuit may comprise a flyback converter, which may comprise an inductive element and a switch in series. The flyback converter may also comprise a diode arranged such that in use current from the flyback converter is passed to the capacitive display in only a single direction.

In certain cases, it is desirable to limit the voltage generated by the discharge current. Accordingly, the drive circuit may further comprise a voltage limiter, such as a zener diode, to limit in use the voltage supplied to the further display. The voltage may be limited to roughly any of the following voltages: 4V, or 5V, or 12V.

According to a second aspect of the invention, there is provided a method of driving a capacitive display, comprising repeatedly charging and discharging the capacitive display using a AC signal having a first, high voltage and on discharging of the capacitive display using the discharge current thereby generated to drive a further device, typically a further display, at a second, lower voltage.

The discharge current supplied to the further display will generally comprise a DC signal. As certain displays, such as some LCDs, require AC, the method may further comprise the step of converting the discharge current to AC.

The further device may be a light emitting polymer (LEP) display, Cholesteric LCD, Electrophoretic displays, Light Emitting Diodes (LEDs) including High Brightness LEDs (HBLEDs), Organic LEDs (OLEDs), or the like. Alternatively, it may be a sounder or the like.

Any of the features of the first aspect of the invention may be applied to the second aspect of the invention and visa versa.

An embodiment of the invention will now be described, by way of example only, with reference to the accompanying drawings, in which:

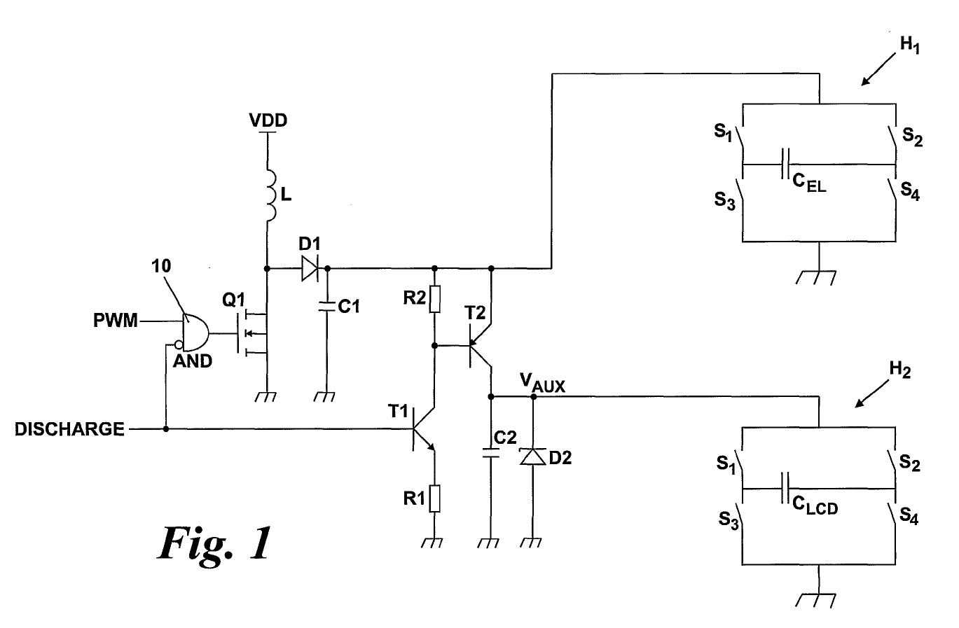

FIG. 1 depicts a circuit diagram showing the drive circuit of a display device according to an embodiment of the invention; and

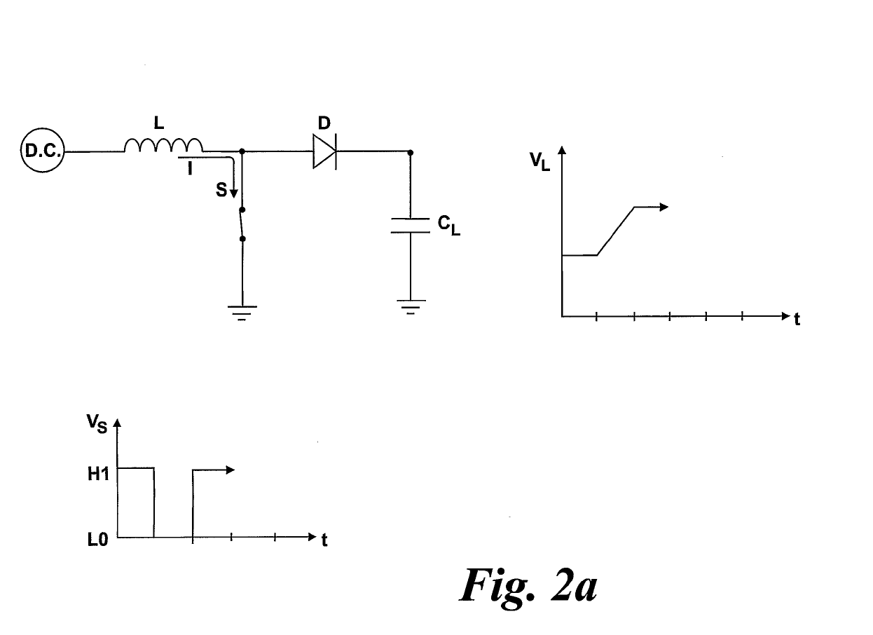

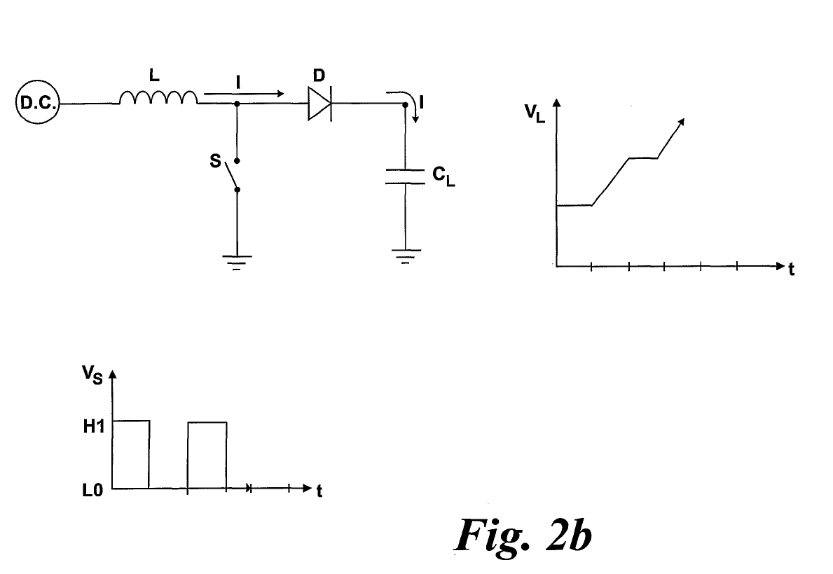

FIG. 2a and FIG. 2b illustrate the operation of a flyback converter for use with the invention.

In the circuit diagram shown in FIG. 1, a low voltage source VDD is connected to a flyback converter formed by an inductor L and a FET switch Q1 in series; the inductor is connected to the drain of the FET Q₁. The low voltage source VDD is connected to the terminal of the inductor not connected to the switch, and the source of the FET is connected to ground. A diode D1 is connected at its first terminal (the anode) to the point between the switch Q1 and the inductor L. The diode D1 may be any other device, generally semiconductor device, connected to act as a diode.

The operation of the flyback converter is well known and is demonstrated in PCT patent application publication number WO02/069674. FIGS. 2a and 2b show an arrangement of a flyback converter for charging a capacitive load to a high voltage. In the invention, the components C_{L} downstream of the diode D in FIG. 2 is an electroluminescent element with an H-bridge as shown in FIG. 1. For the sake of simplicity the capacitive load C_{L} is shown in FIG. 2 without the H-bridge.

As shown in FIG. 2a, the flyback converter comprises a DC supply in series with an inductor L and a switch S. The switch S is connected between the inductor and earth potential. In a practical arrangement, the switch S is provided by a field effect transistor, the output FET. However, for the sake of clarity, in FIGS. 2a and 2b the switch S is shown as a simple switch.

In parallel with the switch S is provided a diode D in series with the capacitive load C_{L}. The capacitive load C_{L} is arranged between the diode and earth potential.

The switch S is controlled by a switch voltage Vₛ which varies over time as indicated in FIG. 2a. When the switch voltage Vₛ is high, the switch S is closed and conducts. The situation is shown in FIG. 2a. When the switch voltage Vₛ is low, the switch S is open and does not conduct. This situation is shown in FIG. 2b.

The circuit shown in FIGS. 2a and 2b operates as follows. While the switch voltage V_{D} is high, as shown in FIG. 2a, current I flows from the DC supply through the inductor L and the closed switch S to earth.

Assuming the voltage on the capacitive load C_{L} is higher than the DC supply voltage, no current flows through the diode D.

When the switch voltage Vₛ goes low, as shown in Figure S is interrupted by the open switch S. However, the energy stored in the magnetic field associated with the inductor L forces the current I to continue flowing and the inductor L generates a sufficiently high voltage that the current I flows through the diode D to charge the capacitive load C_{L}. In this way, with each transition of the switch voltage Vₛ from high to low, the voltage V_{L} on the capacitive load C_{L} is increased, as indicated in FIG. 2b. the diode D prevents current flow back from the capacitive load C_{L} to earth or to the DC supply when then switch S is closed.

It will be seen therefore that the capacitive load CL can be charged to any desired voltage by applying an alternating switch voltage Vs to the switch S. The effect of repeatedly switching switch Q1 in Figure or S in FIG. 2 is that a high voltage (HV) DC (but varying) signal is generated at the second terminal (the cathode) of the diode D1. A capacitor C1 is provided at the second terminal of the diode in order to smooth this DC signal.

The smoothed HV DC signal thereby generated is provided to a first H-bridge H1, grounded at its opposite terminal. A capacitive EL display C_{EL} is connected across the H-bridge. The H-bridge being four switches (S₁, S₂, S₃, S₄) forming two pairs (S₁, S₃ and S₂, S₄), each pair selectively connecting one electrode of the display to either the HV DC signal or to ground. By operating the switches of the H-bridge in pairs, the polarity with which the EL display is connected to the smoothed HV DC supply can be repeatedly changed, thereby generating a HV AC signal across the EL display.

The switching of the switch Q₁ is controlled by a signal applied to its gate from an AND gate 10. This takes as an input a pulse width modulated signal PWM which can be used to control how the switch Q1 switches; by changing the frequency and duty ratio of the PWM signal the operation and hence output voltage and waveform of the HV DC signal can be controlled. The other input to the AND gate is inverted. This is connected to a “DISCHARGE” signal. Given that the relevant input is inverted, the DISCHARGE signal inhibits switching of the switch Q1 and therefore stops the HV DC signal being generated by the flyback converter when the DISCHARGE signal goes high.

The DISCHARGE signal is also connected to transistor cascade T1, T2. The base of T1, an NPN transistor, is directly connected to the discharge signal and switches to conduct when the DISCHARGE signal goes high. A resistor R1 is connected between the emitter of T1 and ground and a resistor R2 is connected between the collector of T1 and the HV DC signal. Given that T1 is connected between ground and a resistor R1 on the one side and a resistor R2 and the HV DC signal on the other, when T1 conducts R1 and R2 form a potential divider. The base of the second transistor T2 in the cascade is driven by this voltage, and so the transistor T2 conducts when T1 does.

When T2 conducts, a conductive path is provided from the EL display C_{EL} to auxiliary power supply V_{AUX}. A capacitor C2 is provided between this auxiliary power supply and ground in order to smooth the signal thus generated. A reverse connected zener diode D2 is provided in parallel with capacitor C2 so as to limit the voltage at V_{AUX} to a value dependent on the diode, typically 12V. This auxiliary power supply V_{AUX} is connected by means of a further H-bridge H2 to a further, LCD display C_{LCD}.

Accordingly, to charge the EL display, the DISCHARGE signal is held low and the PWM signal repeatedly opens and closes switch Q1. This generates a HV DC signal, which is provided via H-bridge H1 to the EL display C_{EL}. In order to discharge the EL display C_{EL}, the DISCHARGE signal goes high, the PWM signal is inhibited from switching the switch Q1 and T2 is switched, to allow current to pass, to allow the EL display to discharge through T2 into further LCD display C_{LCD}; this DC discharge is converted to AC by means of the second H-bridge H2. The voltage thereby generated is typically 4 to 9V, sufficient to operate an LCD display.

Although in the embodiment being described, the voltage generated from the discharging EL display C_{EL} is used to power a second display C_{LCD} it could be used to power any other device, or indeed contribute to powering any other device. That is in some embodiments sufficient power may not be recovered from the EL display C_{EL} to fully power a device and in such embodiments the power recovered may be used to help power the further device. For example, the power recovered from the discharging EL display C_{EL} may be used to power any of the following: LCDs, LEDs (including OLEDs and HBLEDs), Cholesteric LCDs, Electrophoretic displays and the like.

We claim:

1. A display device comprising a capacitive display, a further display and a drive circuit for providing an AC drive signal at a first, high voltage for the capacitive display from a low voltage power source, the drive circuit being arranged such that in use the capacitive display repeatedly charges and discharges and, when the capacitive display discharges, a discharge current from the capacitive display is supplied at a second, lower voltage to the further display.

2. A display device according to claim 1, wherein the second voltage is different from the voltage of the low voltage source.

3. A display device according to claim 1, wherein the further display is a liquid crystal display (LCD).

4. A display device according to claim 1 or, wherein the further display is a light emitting polymer (LEP) display, cholesteric LCD, Electrophoretic display or Light Emitting Diodes.

5. A display device according to claim 1, wherein the discharge current supplied to the further display comprises a DC signal.

6. A display device according to claim 5, further comprising a DC to AC converter for converting the discharge current to AC.

7. A display device according to claims claim 1, wherein the drive circuit comprises a flyback converter.

8. A display device according to claim 7 wherein the flyback converter comprises an inductive element and a switch in series.

9. A display device according to claim 7, wherein the flyback converter comprises a diode arranged such that, in use, current from the flyback converter is passed to the capacitive display in only a single direction.

10. A display device according to claim 1, wherein the drive circuit comprises a voltage limiter, such as a zener diode, to limit in use the voltage supplied to the further display.

11. A display device according to claim 11, wherein the voltage is limited to 4V, 5V or 12V.

12. A method of driving a capacitive display, comprising repeatedly charging and discharging the capacitive display using an AC signal having a first high voltage and on discharging of the capacitive display using the discharge current thereby generated to drive a further device at a second, lower voltage.

13. A method according to claim 12, wherein the further device is a further display.

14. A method according to claim 13, wherein the discharge current supplied to the further device comprises a DC signal.

15. A method according to claim 13, wherein the further display device is an LCD.

16. A method according to claim 15, further comprising the step of converting the discharge current to AC.

17. A method of claim 13 wherein the display is a light emitting polymer (LEP) display, cholesteric LCD, electrophoretic display or light emitting diodes (LEDs).

18. A method of claim 12, w herein the further device is a sounder.
